(19) United States
(12) Patent Application Publication
(10) Pub. No.: US 2023/0167668 A1
(43) Pub. Date: Jun. 1, 2023

(54) ON-VEHICLE DEVICE CONTROLLER

(71) Applicant: TOYOTA JIDOSHA KABUSHIKI KAISHA, Toyota-shi Aichi-ken (JP)

(72) Inventors: Tatsuya SHIMIZU, Okazaki-shi Aichi-ken (JP); Kazuhisa Maeda, Toyota-shi Aichi-ken (JP)

(73) Assignee: TOYOTA JIDOSHA KABUSHIKI KAISHA, Toyota-shi Aichi-ken (JP)

(21) Appl. No.: 17/989,133

(22) Filed: Nov. 17, 2022

(30) Foreign Application Priority Data
Nov. 30, 2021 (JP) 2021-193869

(51) Int. Cl. E05F 15/76; B60P 1/43

(52) U.S. Cl. CPC E05F 15/76; B60P 1/43; E05Y 2400/44; E05Y 2400/45; E05Y 2900/531

(57) ABSTRACT

An on-vehicle device controller controls operation of an on-vehicle device in a vehicle. The on-vehicle device controller acquires vehicle positional information regarding a position of the vehicle and user positional information regarding a position of a user who is to board the vehicle, and controls operation of the on-vehicle device based on a user arriving time of the user arriving at the vehicle, that is calculated from the vehicle positional information, the user positional information, and a moving speed of the user.

### CROSS REFERENCE TO RELATED APPLICATION

This application claims priority to Japanese Patent Application No. 2021-193869 filed on Nov. 30, 2021, which is incorporated herein by reference in its entirety including the specification, claims, drawings, and abstract.

### TECHNICAL FIELD

The present disclosure relates to an on-vehicle device controller configured to control operation of an on-vehicle device.

### BACKGROUND

Systems for automatically opening the door to allow a user to board a vehicle have been proposed. Patent Document 1 discloses that in response to elapse of a predetermined time period with a matching state of an electric key being maintained after a user carrying the electric key approaches a vehicle, it is determined that the user has stopped, and a sliding door would open.

### CITATION LIST

### Patent Literature

[Patent Document 1] JP 2014-141804 A

### SUMMARY

In the above system, the user who is going to board the vehicle has to temporarily stop and wait near the door before boarding, which prevents seamless boarding.

In accordance with an aspect of the disclosure, an on-vehicle device controller that controls operation of at least one on-vehicle device is configured to: acquire vehicle positional information regarding a position of the vehicle; acquire user positional information regarding a position of a user that is to board the vehicle; and control operation of the at least one on-vehicle device based on a user arriving time of the user arriving at the vehicle, calculated from the vehicle positional information, the user positional information, and a moving speed of the user.

The on-vehicle device controller may be configured to calculate the moving speed of the user based on a change in the user positional information within a predetermined time period.

The on-vehicle device controller may be configured to receive the user positional information from a mobile terminal carried by the user through wireless communication.

The at least one on-vehicle device may comprise a door of the vehicle, and the on-vehicle device controller may be configured to complete opening of the door before the user arriving time.

The at least one on-vehicle device may comprise a ramp of the vehicle, and the on-vehicle device controller may be configured to complete deployment of the ramp before the user arriving time.

The at least one on-vehicle device may comprise a door and ramp of the vehicle, and the on-vehicle device controller may be configured to complete opening of the door and deployment of the ramp before the user arriving time.

The on-vehicle device controller may be configured to individually set a door opening time required for opening the door of the vehicle and a ramp deploying time required for deploying the ramp; and set a ramp deployment start time such that the opening of the door starts after completion of the deployment of the ramp, and completes before the user arriving time.

The disclosure allows the door to be in an open state when the boarding user arrives at the vehicle, thereby enabling seamless boarding.

### BRIEF DESCRIPTION OF DRAWINGS

Embodiments of the present disclosure will be described based on the following figures, wherein:

FIG. 1 schematically illustrates an entire configuration of a system including a vehicle including an on-vehicle device controller according to an embodiment, and a user;

FIG. 2 illustrates a sliding door being open and a ramp extending outward of the vehicle (deployed state);

FIG. 3 is a block diagram illustrating a system configuration including a vehicle 1 including the on-vehicle device controller according the embodiment; and

FIG. 4 is a flowchart showing control operation for opening the sliding door and deploying the ramp by a processor forming the on-vehicle device controller in the vehicle.

### DESCRIPTION OF EMBODIMENTS

Embodiments of the disclosure will be described by reference to the drawings, but the disclosure is not limited to the embodiments described below.

### Entire System

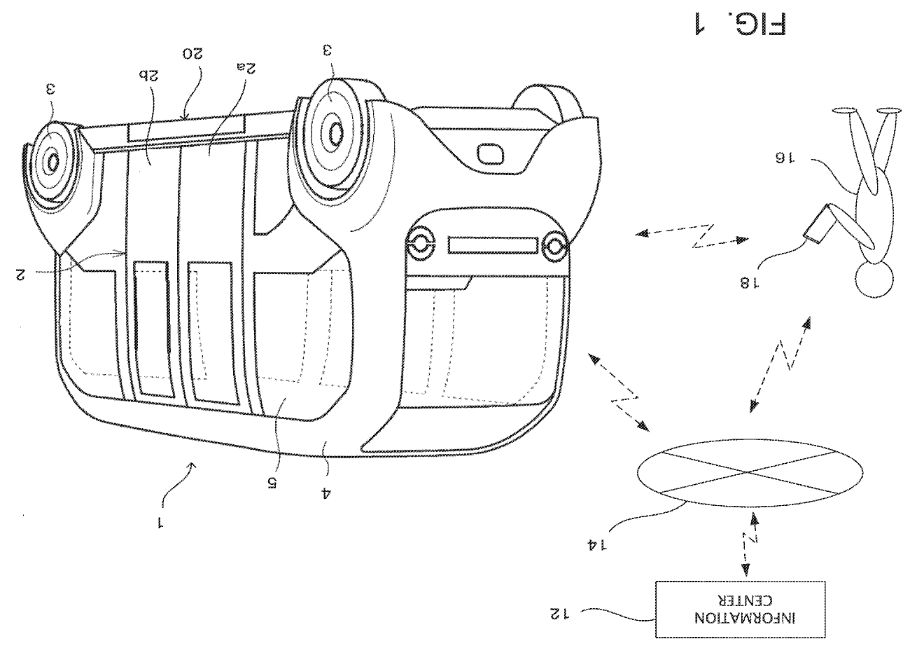

FIG. 1 schematically illustrates an entire configuration of a system including a vehicle including an on-vehicle device controller according to an embodiment, and a user.

A vehicle 1 is an autonomous vehicle, and is connected to an external information center 12 via a communication network 14. A user 16 carries a mobile terminal 18 that is communicable with the vehicle 1 and the information center 12 via the communication network 14. The mobile terminal 18 may be directly communicable with the vehicle 1 through wireless communication.

The user 16 accesses the information center 12 in advance of boarding the vehicle 1, to make reservation for boarding the vehicle 1. The reservation includes user information, boarding place information, and boarding time information. The user 16 then walks toward the boarding place where the vehicle 1 stops, and boards the vehicle 1 at the boarding place.

In the embodiment, the vehicle 1 has opened the door before arrival of the user 16 at the boarding place, to allow smooth boarding of the user 16.

### Vehicle Configuration

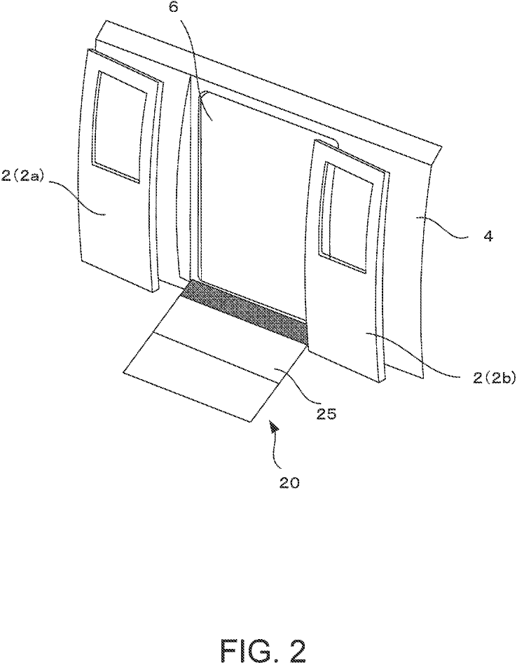

As illustrated in FIG. 1, the vehicle 1 is a ramp-equipped vehicle. FIG. 2 illustrates a sliding door 2 being open and a ramp 25 extending outward of the vehicle 1 (deployed state).

In this example, the vehicle 1 is a motor vehicle to be driven by a motor and is capable of autonomous driving. The vehicle 1 includes driving wheels 3 on respective four corners at lower portions of a vehicle body 4, and performs four-wheel driving by employing in-wheel motors. The vehicle body 4 includes windows 5 on respective four sides, and includes a sliding door 2 on a left side of the four sides. The vehicle 1 further includes an electric-powered ramp device 20 under the sliding door 2 on the vehicle body 4.

The sliding door 2 includes two door panels 2a and 2b that are moved along the length of the vehicle in opposite directions by a door opening/closing mechanism (not shown) to thereby open or close an entrance 6.

The electric-powered ramp device 20 normally stows the ramp 25 within the vehicle 1 such as under the floor (see FIG. 1), and deploys the ramp 25 to extend outward to allow boarding and exiting of passengers (see FIG. 2). The ramp 25 is especially useful for boarding and exiting of a user in a wheelchair.

The electric-powered ramp device 20 includes the ramp 25 and a ramp driving mechanism (not shown). The ramp 25 includes three ramp panels, for example, which may be superposed on each other for stowing, and may move relative to each other for deployment. The ramp panels may be movable relative to each other but undetacheable from each other.

Axles of the four driving wheels 3 are attached to the vehicle body 4 via a suspension member (not shown). The suspension member may include a vehicle height adjusting mechanism that may lower the vehicle body for opening the sliding door 2 to deploy the ramp 25, and raise the vehicle body for closing the sliding door 2 to stow the ramp 25.

### System Configuration

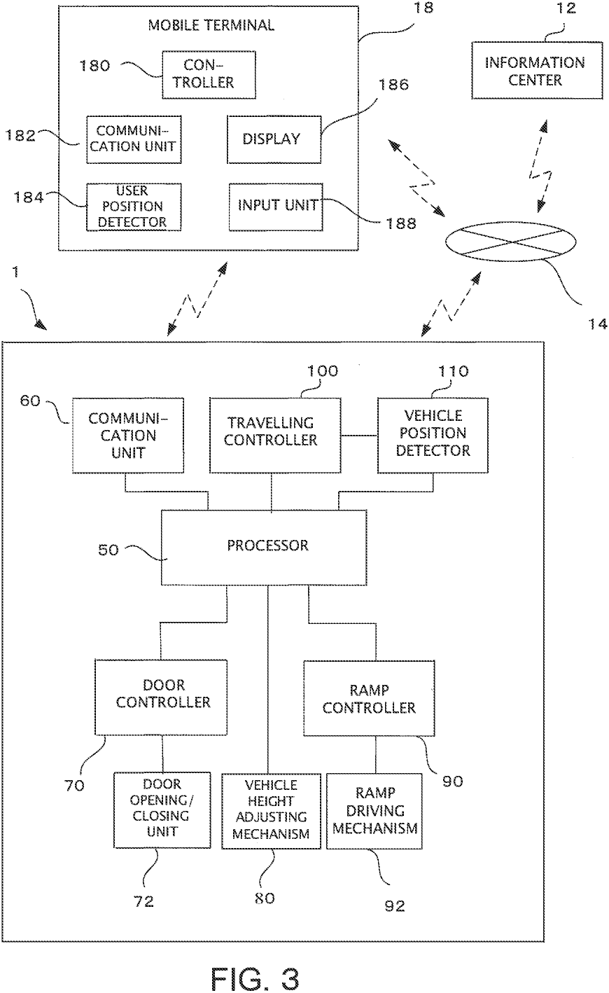

FIG. 3 is a block diagram illustrating a system configuration including the vehicle 1 including the on-vehicle device controller according to the embodiment.

### Functional Configuration of Vehicle

The vehicle 1 includes various on-vehicle devices, and FIG. 3 illustrates a configuration including the sliding door 2 and the ramp 25 as targets to be controlled. In this example, a processor 50 functions as the on-vehicle device controller.

A travelling controller 100 controls travelling of the vehicle 1. In this example, the vehicle 1 is an autonomous driving or self-driving vehicle, and autonomously travels along a predetermined route by reference to map data and front images captured by a camera. A vehicle position detector 110 is therefore connected to the travelling controller 100 to continuously detect the present position of the vehicle 1. The vehicle position detector 110 may be a measurement system that uses satellite, such as a GPS, and other types of position detectors. The travelling controller 100 receives various information, and controls a driving motor, brake, and a steering mechanism, for example, based on the received information. The vehicle 1 may be a normal vehicle operated by a driver, or an autonomous vehicle that allows departure of the vehicle or opening and closing of the sliding door 2, for example, to be performed by an occupant operating buttons, for example. For autonomous driving, the vehicle 1 communicates with an external operation management center to acquire data required for autonomous driving control. The travelling controller 100 may therefore have a communication function, or may perform various types of communication through a communication unit 60 which will be described below.

The processor 50 is composed of a computer, and executes various programs to thereby perform various data processing for controlling operation of various elements of the vehicle 1.

The communication unit 60 is externally communicable wirelessly with various elements. The communication unit 60 communicates with the information center 12, for example, to acquire data necessary for autonomous driving control as described above, and also communicates with the mobile terminal 18, such as a smartphone, carried by an approaching person. This communication may be direct short-distance communication, or communication through a communication network such as the Internet, or communication through the information center 12. As such, the processor 50 is able to exchange necessary data with the mobile terminal 18 via the communication unit 60.

A door controller 70, a vehicle height controller 80, and a ramp controller 90 are connected with the processor 50 to control opening and closing of the sliding door 2 and deployment of the ramp 25. More specifically, the door controller 70 is connected with the door opening/closing mechanism 72 which controls opening and closing of the sliding door 2. The ramp controller 90 is connected with a ramp driving mechanism 92 to control deployment and stowing of the ramp 25. The ramp driving mechanism 92 may be configured to deploy and stow the ramp 25 including three step panels, for example, by expansion and contraction of a wire. FIG. 1 illustrates a stowed state of the ramp 25, and FIG. 2 illustrates deployed state of the ramp 25. The ramp 25 in the deployed state allows the user in a wheelchair to board and exit the vehicle 1 by the ramp 25.

The individual elements described above may employ various known configurations.

### Configuration of Mobile Terminal

The mobile terminal 18 may be a typical smartphone. In this example, the mobile terminal 18 includes a controller 180, a communication unit 182, a user position detector 184 that detects the present position of the user, a display 186 that displays information, and an input unit 188 for inputting various data.

The controller 180 is composed of a computer that performs data processing. The communication unit 182 externally communicates through Wi-Fi (registered mark), mobile lines, or various wireless communication methods, for example. The user position detector 184 may be a present position detector such as a GPS device. The display 186 may be a liquid crystal display or an organic EL display, for example. The input unit 188 may be a touch screen on the display 186.

The information center 12 includes a large size computer and performs various data processing, such as operation management of the vehicle 1 or reception of reservations for boarding the vehicle 1 in this example.

### Door Opening/Closing Control

The on-vehicle device controller according to the embodiment opens the sliding door 2 of the vehicle 1 in accordance with the arriving time of the user 16 at the vehicle 1, based on the position and the speed of the user 16 and the vehicle position information.

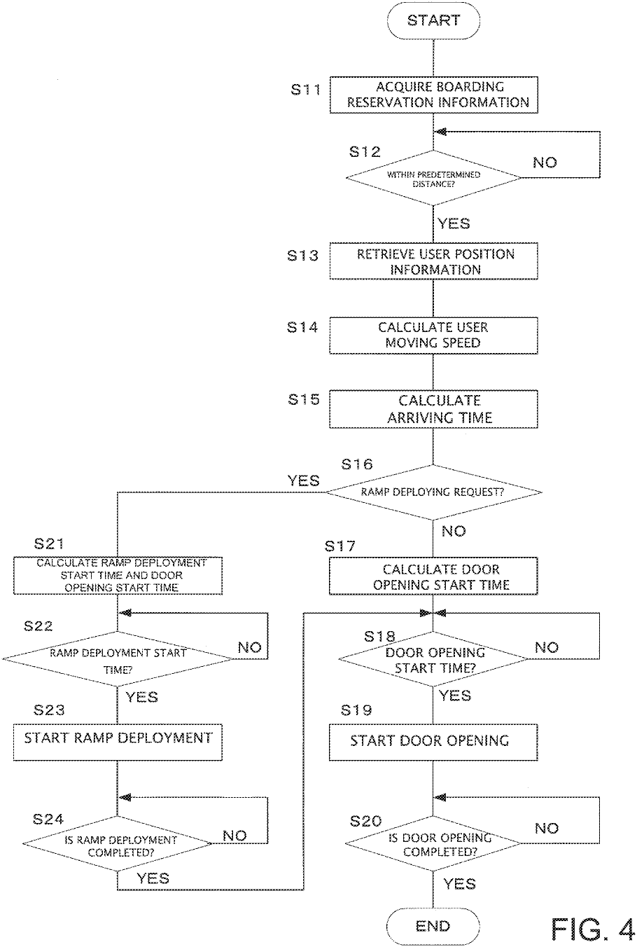

FIG. 4 is a flowchart showing control operation for opening the sliding door 2 and deploying the ramp 25 by the processor 50 forming the on-vehicle device controller in the vehicle 1.

The user 16 uses the mobile terminal 18 or a PC, for example, to access the information center 12 and make a boarding reservation. The boarding reservation may be performed by a known method, and reservation information including when, where, and which vehicle 1 to board, a user ID, contact information, reservation number, and other information, is recorded. The vehicle 1 heads for the boarding place in accordance with the reservation. The vehicle 1 such as a scheduled bus operates as scheduled and expects boarding of the user 16 at a stop in the reservation information.

The vehicle 1 acquires boarding reservation information prior to start of traveling or during traveling (S11).

Then, whether or not the user 16 is within a predetermined distance from the vehicle 1 is determined (S12). This determination in step S12 is performed by reference to the reservation information of the user 16 through communication with the mobile terminal 18 of the user 16. For example, the determination in step S12 may start a predetermine time, such as five minutes, before the scheduled boarding time. In this example, as it is assumed, as a precondition, that the vehicle 1 has arrived at the boarding place, the position of the vehicle 1 is assumed to be located at the boarding place, and the distance from the user position to the boarding place is determined. For the vehicle 1 that is still moving, the distance from the user position to the boarding place is similarly determined, because the user 16 is moving to the boarding place.

The predetermined distance may also be determined based on determining whether or not the mobile terminal 18 and the vehicle 1 (located at the boarding place) are directly communicable, with a communicable distance being about 100 m in the case of BLUETOOTH (registered mark) communication. The mobile terminal 18 may further communicate with the vehicle 1 via the communication network 14 to inform the vehicle 1 of the position of the mobile terminal 18, and the vehicle 1 may then perform the determination. The position of the user 16 may also be acquired from the detection result from the user position detector 184 of the mobile terminal 18, and the position of the vehicle 1 may be acquired from the detection result from the vehicle position detector 110. Further, both the mobile terminal 18 and the vehicle 1 may continuously provide positional information to the information center 12, and the information center 12 may determine the distance between the mobile terminal 18 and the vehicle 1.

In response to determining NO in step S12, the process in step S12 is repeated. In response to determining YES, the user positional information is retrieved for a predetermined time period (S13). The processor 50 calculates the moving speed of the user based on a change in the user positional information within the predetermined time period. If the user 16 may communicate with the vehicle 1 while the user 16 is outside the predetermined distance from the vehicle 1 as well, the user positional information of the user 16 outside the predetermined distance may be retrieved.

Subsequently, the moving speed of the user 16 is calculated from a plurality of acquired user positional information items (S14). As the user 16 typically walks to the boarding place, the moving speed is a walking speed. The moving speed is calculated from changes in the positional information detected in the mobile terminal 18 for a predetermined time period. The mobile terminal 18 may transmit the calculated moving speed to the vehicle 1, or the mobile terminal 18 may sequentially transmit the positional information to the vehicle 1, which then may calculate the moving speed of the user 16. Further, the information center 12 may calculate the moving speed of the user 16 and provide the calculated moving speed to the vehicle 1.

Alternatively, the moving speed of the user 16 may be preset based on the average walking speed of a human or the walking speed previously informed.

Upon calculation of the moving speed in step S14, the arriving time of the user 16 to the boarding place is calculated based on the position of the user 16 at that time and the distance to the boarding place (S15).

Further, whether or not deployment of the ramp is requested is determined (S16). A ramp deploying request is included in the reservation by the user 16 if necessary. This enables determination of whether deployment of the ramp is requested from the reservation content.

In response to NO in the determination in step S16, meaning that only opening of the door is necessary, the door opening start time is calculated to allow the door to be opened, especially to be completely opened, before or immediately before the arriving time of the user (S17).

Then, whether or not the current time is the door opening start time is determined (S18), and upon reaching the door opening start time, opening of the door starts (S19). Whether or not the door opening is completed is determined (S20), and in response to completion of the door opening, the process ends.

In response to YES in step S16, in addition to the door opening, deployment of the ramp 25 is to be performed. Therefore, both the ramp deployment start time and the door opening start time are calculated (S21). Deployment of the ramp 25 is performed while the door is closed, because it is highly likely that passengers would step on the moving ramp 25 when the door is open. In step S21, the ramp deployment start time is calculated by adding an extra time to the total time obtained from the ramp deployment time required for deployment of the ramp 25 and the door opening time required for opening of the door.

Upon reaching the ramp deployment start time (YES in S22), the ramp deployment starts (S23). In response to completion of deployment of the ramp 25 (YES in S24), the process proceeds to step S18 where the process for opening the door is performed (S18 and S19). In response to completion of door opening (YES in S20), the process ends. That is, the processor 50 individually set a door opening time required for opening the door of the vehicle, and a ramp deploying time required for deploying the ramp individually; and set a ramp deployment start time such that the opening of the door starts after completion of the deployment of the ramp, and completes before the user arriving time.

According to the embodiment, the vehicle 1 that is an autonomous vehicle communicates with the mobile terminal 18, such as a smartphone, of the user 16 to previously confirm scheduled boarding, or confirm the reservation content, and also to detect the user position and the user moving speed using the positional information of the mobile terminal 18. This configuration enables prediction of the arriving time of the user at the boarding place by comparison between the user position and the vehicle position, and enables the door to be opened at an appropriate time in accordance with the predicted arriving time, thereby enhancing convenience for boarding. In other words, this configuration operates to open the door in accordance with the predicted arrival of the user 16 to thereby enable seamless boarding.

The positional information may be acquired not only by GPS measurement but also by measurements based on radio waves from Wi-Fi access points or 3G/4G/5G base stations in the mobile body communication system. Further, communication on a one-to-one basis such as BLUETOOTH may be employed for communication between the vehicle 1 and the mobile terminal 18.

The positional information can thus be acquired even in places where data of measurement using the satellite, such as GPS, cannot be received, including indoor or underground places.

Idling and air conditioning may be started using the predicted arriving time of the user 16 to the vehicle 1 as a trigger.

The predicted arriving time of the user 16 may be calculated in further combinations with communication with infrastructures including roadside beacons, road cameras, cameras of the vehicle 1, for example.

1. An on-vehicle device controller to control operation of at least one on-vehicle device on a vehicle, the on-vehicle controller configured to:
acquire vehicle positional information regarding a position of the vehicle;
acquire user positional information regarding a position of a user that is to board the vehicle; and
control operation of the at least one on-vehicle device based on a user arriving time of the user arriving at the vehicle, that is calculated from the vehicle positional information, the user positional information, and a moving speed of the user.

2. The on-vehicle device controller according to claim 1 configured to:
calculate the moving speed of the user based on a change in the user positional information within a predetermined time period.

3. The on-vehicle device controller according to claim 1 configured to:
receive the user positional information from a mobile terminal carried by the user through wireless communication.

4. The on-vehicle device controller according to claim 1, wherein
the at least one on-vehicle device comprises a door of the vehicle, and
the on-vehicle device controller is configured to complete opening of the door before the user arriving time.

5. The on-vehicle device controller according to claim 1, wherein
the at least one on-vehicle device comprises a ramp of the vehicle, and
the on-vehicle device controller is configured to complete deployment of the ramp before the user arriving time.

6. The on-vehicle device controller according to claim 1, wherein
the at least one on-vehicle device comprises a door and ramp of the vehicle, and
the on-vehicle device controller is configured to complete opening of the door and deployment of the ramp before the user arriving time.

7. The on-vehicle device controller according to claim 6 configured to:
individually set a door opening time required for opening the door of the vehicle, and a ramp deploying time required for deploying the ramp; and
set a ramp deployment start time such that the opening of the door starts after completion of the deployment of the ramp, and completes before the user arriving time.
